(19) United States
(12) Patent Application Publication
(10) Pub. No.: US 2001/0032115 A1
(43) Pub. Date: Oct. 18, 2001

(54) System and methods for internet commerce and communication based on customer interaction and preferences

(76) Inventor: Michael Goldstein, Purchase, NY (US)

Correspondence Address: GREENBERG-TRAURIG, 1750 TYSONS BOULEVARD, 12TH FLOOR, MCLEAN, VA, 22102, US

(21) Appl. No.: 09/741,840

(22) Filed: Dec. 22, 2000

Related U.S. Application Data
(60) Provisional application No. 60/171,578, filed on Dec. 23, 1999.

(51) Int. Cl. G06F 17/60

(52) U.S. Cl. 705/10; 705/14

(57) ABSTRACT

A system and methods that allow the creation of a custom Internet browsing experience based on consumer preferences. The system may give consumers an opportunity to participate in polls and surveys, thus allowing a consumer to help shape the world around them. The present invention allows tracking of consumer survey results, consumer spending habits and brand preferences to allow highly targeted marketing. In exchange for allowing monitoring of consumer behavior patterns, consumers are rewarded with various incentives including electronic currency.

This application claims the benefit of U.S. Provisional Application 60/171,578, filed Dec. 23, 2000, which is incorporated herein by reference.

### FIELD OF THE INVENTION

The invention relates to the fields of marketing, public opinion polling, consumer preference collection, demographic aggregation, and electronic content delivery. More particularly, the present invention delivers custom, dynamic, and real-time programming content to the government, as well as the news, media, and entertainment industries or any other entity that chooses to use the present invention (“customers”). In addition, the present invention allows customers to better target their products, services, and communications based on consumer opinions, preferences, and demographic information (“consumer data”). The present invention provides this functionality by collecting consumer data through surveys, polls, and other public opinion gauges (“surveys”).

### BACKGROUND OF THE INVENTION

The World Wide Web (“the web”) provides a low cost solution for companies and individuals wishing to make information, such as product specifications, available to the general public. Some companies also use the web to sell products to consumers who visit a web site. Unfortunately, marketing on the Internet has been difficult for both manufacturers and producers due to the number of potential advertising locations. In an effort to provide more attractive advertising space, some companies have created “portal” sites.

A portal site may allow a consumer to create and modify an account on that web site. Personal information, such as a consumer's name, E-mail address, postal mail address, and areas of interest, is entered by the consumer and is stored on the portal as a “profile” of that consumer. In exchange for divulging personal information, a custom “home page” is then displayed based on information in a profile.

Although portal sites generate advertising revenue for the “host” company, advertising is not the only income generated by a portal. Portal hosts frequently sell information stored in consumer profiles to a variety of marketers. Sale of consumer profile information is typically done without explicit permission from or notification to those profiled. Licensing and other use agreements may require consumers to allow the sale of personal information, disclosed as part of creating an account, registering a product or warrantee, downloading software, or otherwise interacting with a company, to a third party. Consumers may be able to “opt-out” of such agreements, but clauses detailing steps necessary to opt-out are typically buried in an agreement and may be worded to confuse a consumer.

While many portal hosts frequently sell consumers' information assets, stored in profiles, to a variety of marketers, they may not adequately and equitably compensate consumers for their information, nor does the consumer know how the information has been used, disseminated and/or bartered. Most portal sites are not held accountable for the proper, equitable, and enthusiastic management of the consumers' valuable resources.

Although personal information given when creating a user profile may be accurate at the time it is entered, there are no guarantees that such information will not become outdated. Many portal sites do not allow consumers to maintain or manage user profile information, thus allowing information stored in a consumer profile to become outdated and irrelevant.

Further complicating the situation for the consumer, of the few sites that allow profile maintenance, each allows consumers to maintain profiles in different ways, under different circumstances, and at different points in time. This may create a confusing and inaccurate series of profiles distributed randomly throughout the web. When this outdated information is used as a basis upon which direct mail or other information is sent to consumers, consumers may be forced to endure marketing materials that are irrelevant, undesired, or inappropriate.

### SUMMARY OF THE INVENTION

The present invention (“the system”) improves upon the prior art by keeping parts or all of a consumer profile, referred to as consumer personal information, in a secure and confidential repository. Consumers may specify which consumer personal information may be released, to whom consumer personal information should be released, and under what circumstances consumer personal information may be released.

In addition, unlike known portals, the present invention allows, and encourages, consumers to easily and continuously update, manage and refine their consumer personal information. Consumer personal information may be updated through opinion, preference, and demographic collection methods, including, but not limited to, surveys and public opinion polls, as well as, various automated and on-line, behavior and navigation monitoring and tracking processes. A consumer who registers with the present invention (a “member”) may quickly and easily edit his or her consumer personal information, thus improving consumer personal information data reliability. The present invention may offer detailed consumer personal information to customers, (business, the media, and the government, or any other entity, which is desirous of ways to better target goods and services to the marketplace), thus maximizing the value of consumer personal information to customers, as well as members.

A consumer may be encouraged to update and edit consumer personal information through rewards or incentives. In addition, a consumer may be rewarded for participating in other activities, including, but not limited to, surveys; polls; market research; or visiting web sites maintained by a customer, advertiser, business partner, or other system affiliate. The present invention can provide such rewards in the form of “electronic currency” or any other reward type such as discounts, sweepstakes entrance tickets, etc., as customary in loyalty programs.

Electronic currency may be used in lieu of other forms of payment when a purchase is made. Electronic currency provided by the present invention may be underwritten by a bank or other financial institution or organization, such as Visa, MasterCard, or American Express, to permit the worldwide acceptance of such electronic currency. Electronic currency may also be exchanged for credit in other loyalty programs, such as, but not limited to, airline miles.

Electronic currency may be used as an incentive or reward for sharing and exchanging opinions, preferences, and demographic information with clients and other members. Electronic currency may also be given as an incentive or reward for using or purchasing products and/or services from “co-branding partners”, and electronic currency may be given away as a prize in sweepstakes. Purchases made using electronic currency provided by the present invention may also be eligible for discounts or other incentives when items are purchased from “merchant partners”.

Although initially targeted at electronic commerce, electronic currency may also be available for payment of more traditional transactions. For example, a member account may be accessed from an Automated Teller Machine (“ATM”), thereby allowing both deposits and withdrawals, as with a traditional bank account. Access to electronic currency may blur the distinction between on-line and traditional shopping, and enable and encourage more businesses to begin on-line sales.

The present invention may be used by customers to improve their Internet business methods. Most companies doing business over the Internet do so as an alternative means of reaching consumers and suppliers, thereby moving a traditional business model for distribution of goods and services from one based on paper to an electronic system. While an electronic version of the traditional business model increases efficiencies, it does not take advantage of the true potential of doing business on the Internet. To take advantage of the Internet, information is necessary that helps customers market their products and services to potential consumers.

The present invention provides tools for customers to be made aware of what issues the consumers, and the marketplace, are giving voice to. The invention allows for shifts in attitudes and preferences to be carefully monitored so business strategies can be changed and modified quickly. Identifying customers and focusing on their personal preferences, strengthens customer relationships and allows businesses to perform more responsively and profitably. This not only requires businesses to gather and remember individual information about consumers, but to use that information to target and focus products and services, thereby, personalizing their treatment of the market, one consumer at a time.

The present invention permits customers to collect and/or review this consumer information, refine the same, and either communicate to consumers, as a series of individuals or segments, in an organized and multi-tiered manner, or market to the same people, insuring that they receive the most relevant offers of goods, services or content, based on their dynamic and unique needs and wishes.

The present invention utilizes many vehicles for customers to communicate and/or market to consumers. They include, but are not limited to, advertisements, direct mail, or other forms of targeted marketing (“advertisements”), to be directed at particular market segments represented by members of the system. Advertisements submitted for distribution may be classified based on various criteria, such as, but not limited to, product type; advertisement type, which may include, but is not limited to, print, “banner”, or E-mail advertisements; and proposed delivery method. A submitted advertisement is delivered to a member only when his or her profile indicates a willingness to receive advertising of a type submitted by a customer.

A customer may also direct surveys and public opinion polls, as well as, various automated and on-line, behavior and navigation monitoring and tracking processes to determine marketability of certain ideas, products, services, candidates, news, media, forms of entertainment, and the like. Members participating in surveys may be rewarded with electronic currency, or other forms of enticement, thus providing an incentive to consumer members to participate. Surveys deployed by the system may allow members to shape the world around them, express their opinions and preferences, and make a difference in society and the marketplace.

The present invention provides a rewarding and interactive community, ultimately, becoming the dominant place where consumers can go to participate in the issues that make a difference. By interacting with the present invention, users will help to refine, change, improve, and influence public issues and policies, and consumer services and products.

In addition, members are rewarded for maintaining personal information stored in the system. Members may also receive rewards for participating in various activities, such as, but not limited to, promotions and surveys, or for viewing advertisements, or corporate communications and public affairs materials.

Information maintained in member consumer personal information may also be used to market products or services, or as a mechanism to custom tailor corporate communications to them. Member profile information and the cumulative results of surveys conducted by the system may be used to test the marketability of products, services, candidates, news, entertainment, or other issues. Privacy and confidentiality of Member profile information is also a high priority in the present invention.

The present invention maximizes the value of consumer information to consumers, as well as, business, the media, and the government, or any other entity, which is desirous of ways to better target goods and services to the marketplace.

The value of consumer data to the customer is expanded by virtue of the fact that the consumer information is more detailed, comprehensive and accurate, and has been explicitly provided by consumers for specific uses. For the consumer, the information is packaged and marketed in such a way, as to insure the maximum potential for promotion and sale to qualified and unobjectionable buyers. Furthermore, the privacy and security of their information assets are greatly enhanced.

### BRIEF DESCRIPTION OF THE DRAWINGS

FIG. 1 is a block diagram illustrating the major software components and various entities of the present invention, and how the components and entities interact;

FIG. 2 is a block diagram illustrating portions of the present invention involved in generating lists of potential consumers; and

FIG. 3 is a block diagram illustrating the interaction portions of the present invention.

### DETAILED DESCRIPTION OF THE INVENTION

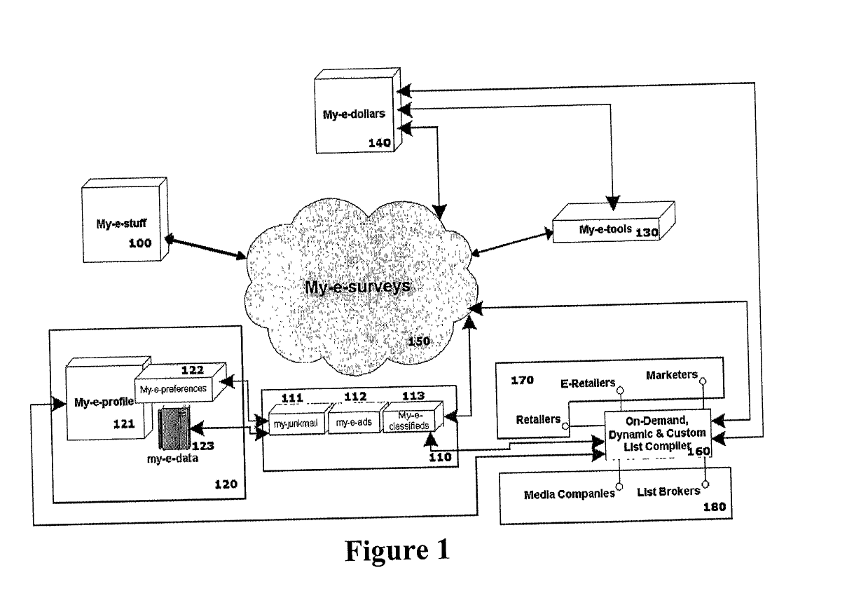

FIG. 1 is a block diagram illustrating the major software components and various entities in a preferred embodiment of the present invention and the interaction of those components and entities. My-e-surveys 150 represents an interface presented to a user as a user interacts with the system. My-e-surveys 150 may allow a user to request information from the system, and may allow the system to display information to a user.

In the presently preferred embodiment, My-e-surveys 150 may be accessed when a World Wide Web browser (“web browser”) requests information from a World Wide Web server (“web server”) associated with the present invention. Examples of web browsers include Internet Explorer, produced by Microsoft of Seattle, Washington; Netscape Navigator, manufactured by Netscape of Mountain View, California; and Amaya, maintained by the World Wide Web Consortium. Examples of web servers include Microsoft Internet Information Server, Netscape Enterprise Server, and Apache Server, manufactured by The Apache Software Foundation of Lincoln, Nebr.

A web browser is software that may be installed on a user computer that converts text encoded in a standardized language to information that may be displayed to a user. Samples of standardized languages include Hypertext Markup Language (“HTML”), Extensible Markup Language (“XML”), and Standardized Generalized Markup Language (“SGML”).

Encoded text is traditionally delivered to a web browser as a “page” or “web page”. Each web page may contain text, graphics, sounds, and/or video. A collection of one or more web pages may be referred to as a “web site”. Content to be displayed as part of a web site may be delivered by a web server. A web server may consist of a program running on a single computer, or a collection of programs running on separate computers, which may deliver content from one or more sources to a web browser.

Using FIG. 1 as an example, My-e-dollars 140, which is described in more detail later in this specification, may be a database stored on a computer other than that which is used to store My-e-surveys 150. My-e-dollars may be inaccessible to the Internet, but a web server may provide an interface to information stored in My-e-dollars 140. To further expand upon this example, a member may use a web browser, illustrated in FIG. 1 as part of My-e-surveys 150, to request an electronic currency account balance. A web browser may pass a balance inquiry to a web server acting as part of My-e-surveys 150. A web server may relay an inquiry to My-e-dollars 140, and My-e-dollars 140 may return a balance to a web server. A web server may create a web page or portion of a web page to display balance information based on information returned from My-e-dollars 140. A web page may then be passed to a web browser acting as part of My-e-surveys 150.

In addition to interfacing with My-e-dollars 140, a web server acting as part of My-e-surveys 150 may also exchange data with other system components, such as My-e-stuff 100, My-e-tools 130, and My-e-profile 121 (each of which is described in more detail later in this specification), and may also provide other services. Collectively, a web server and a web browser, acting as portions of My-e-surveys 150, may serve as an interface to tools, data, and resources available both as part of the present invention and the Internet as a whole.

In a preferred embodiment of the present invention, Consumer Members will provide opinions, preferences, demographic information, and other detailed personal information (“Member Personal Information”) through the present invention. The invention may provide this functionality by collecting Member Personal Information through surveys, polls, and other public opinion gauges, as well as, various automated and on-line, behavior and navigation monitoring and tracking processes (“surveys”). Members will be rewarded for the provision of this information, and it's timely maintenance. Electronic currency, My-e-dollars 140, may be used as an incentive or reward for sharing and exchanging opinions, preferences, and demographic information with clients and other members.

Through the present invention, the Member Personal Information is marketed, on behalf of the member, to customers. Information is shared with Customers and other third parties, with the explicit approval of members. Members are then rewarded and Member account information updated.

My-e-dollars 140 or Loyalty Currency is awarded to Members for participating in any or all of the following my-e-dollar events:

1. Become a Member

2. Make a survey (regular or linked)

3. Further my-e-dollar Awards:

a. Survey of the Day (Topic, Community or Site level)

b. Achieving “Top 10 Survey” Status

c. Highest % threshold based on # votes/total votes on site, Community or Topic (midnight-midnight EST)—daily, weekly and monthly—three thresholds

4. Take a Survey

5. Entering personal data

6. Disclosure of personal data—different data disclosed carries different My-e-dollars 140 reward levels

7. Update/Maintain personal data

8. Personal data “sold”

Rewarding of Consumer Members When Customers Use Information Assets.

The present invention also reward consumer members when customers use the information assets and serves to equate the dissemination/sharing/sale of Consumer Member Personal Information Assets to the sale of other forms of Intellectual Property such as music and literature. Anytime that a member's Personal Information is “tapped into,” in accordance with his or her preferences, and the information results in the sale/license of said Personal Information, that “event” is recorded in a members loyalty currency account. The present invention serves to “level the playing field,” bringing the Consumer Member into a partnership with businesses, the media, government, and other Customers; sharing in the compensation with the Member, each time Customers pay for the use of Members Personal Information Assets.

Members will be able to check their own accounts, and see, not only what surveys they have taken or made, and their loyalty currency balances, but also to see their transaction histories. Under the present invention, transaction histories may show all activities that earned the member rewards. Furthermore, these account histories enumerate how and when Customers of the present invention, have utilized Member Personal Information and finally, how the Member has been rewarded for such transactions.

The present invention may also allow members to create a customized system interface by entering information into My-e-preferences 122. My-e-preferences 122 can store member demographic information, such as, but not limited to, number of children; make, model, and year of vehicles owned; geographic region in which consumers work or live, or to which they frequently travel; and responses to surveys presented by My-e-surveys 150.

The present invention will provide a way to input, and manage the opinions, preferences, demographic information, and other detailed personal information (“Member Personal Information”) maintained for members of the invention within My-e-preferences 122. The invention will provide tools for the member to both determine and authorize as to how their information will benefit them, in addition to, when and under what circumstances their information can be released to third parties. This functionality of the invention will provide for rapid, dynamic, and on-going management of a member's “Information Assets.”

In addition, in the preferred embodiment, the present invention may allow the ability for members to manage personal data and designates levels of information available to customers. Under the present invention, Members may choose to provide varying levels of Personal Information under the invention. Choosing such a level, will determine the fields presented to the Member for member data population. Each level may represent differing sensitivity of data they are comfortable providing to customers of the invention. The invention could allow for this multi-level Personal Information entry, with each subsequent level of information having additional rewards associated with it, as well as, additional privacy safeguards.

Members may designate the level of sensitivity of data they are comfortable providing to customers of the invention, by possibly assigning a Dissemination Factor, such as 1, 2 or 3, in an information disclosure field.

In addition, to the present invention's inherent setting of privacy levels for each possible field of information, the present invention may provide functionality for the provision of certain “switches” which the member can turn on or off. For example, a member may have chosen to allow his or her telephone number to be provided to customers. Due to personal circumstances, the member may choose that they no longer wish their phone number to be disseminated.

The present invention may incorporate the following or similar designations to effectuate the above:

Privacy Value—defines the relative economic value of specific Personal Information fields.

Dissemination Level—defines the sensitivity of specific Personal Information fields, and may be a representation of a member's comfort level in providing access to the information to customers of the invention.

Although My-e-profile 121 can also provide customers with demographic summaries about a given set of members, member identities will be hidden unless disclosure is authorized by a member. My-e-preferences 122 may also store data from external demographic collection sources and such data can also be provided to customers as part of a demographic summary.

My-e-profile 121 allows customers to request notification whenever information stored in My-e-data 123 or My-e-preferences 122 includes key words or phrases. In addition, My-e-profile 121 may allow customers to set parameters associated with such notifications, including, but not limited to, the number of My-e-surveys 150 survey results required before such a notification can be issued, or the number of times a key word or phrase must appear in a news story before such a notification can be issued. This service is know as Web Clipping.

Information stored in My-e-profile 121 may be gathered through a variety of means, including, but not limited to, registering and becoming a member of the present invention, maintaining member my-e-preferences, opinion, preference, and demographic collection methods, such as, surveys and public opinion polls, as well as, various automated and on-line, behavior and navigation monitoring and tracking processes.

Information presented by My-e-surveys 150 may include a home page, or custom web page, which is generated based on settings stored in My-e-preferences 122. A home page generated by My-e-preferences 122 may consolidate information of interest to a consumer, such as, but not limited to, news, sports, weather, stock reports, account balances generated by My-e-dollars 140, search results and stock quotes generated by My-e-tools 130, advertisements generated by my-e-ads 112, a survey or surveys created by My-e-surveys 150, a list of the top 10 surveys from My-e-surveys 150 surveys, a list of the 100 most recently created surveys, and a list of the 100 most recently taken surveys, or combinations of the above into a single location that also provides easy access to other resources. Such a consolidated interface can provide a consumer with a convenient starting point from which the Internet can be accessed.

As a web page is created, a web server acting as part of My-e-surveys 150 places surveys and other components in the appropriate sections, based on a “Community” and “Topic” structure. According to individual members My-e-preferences 122, a list of acceptable or unacceptable communities and topics (“topic list”) may be requested by My-e-surveys 150 from My-e-preferences 122.

My-e-preferences 122 can store personal information about an individual member, such as a member's age, sex, income, address, telephone number, user interface preferences, personal information disclosure preferences, and the like. Members of the present invention may receive incentives for maintaining such personal information, as well as demographic information stored in My-e-preferences 122. To further ensure members update this personal information in a timely manner, periodic notifications may be sent to a member or presented to a user as part of a home page or other means of communications, generated by My-e-surveys 150.

In some instances, members may specify that personal information stored in My-e-preferences 122 can be released to a specific individual or customer. Such occurrences may be tied to a request for information, willingness to participate in a research project, a desire to purchase a given item, or other such member-generated acts.

Aside from those member-generated acts, information stored in My-e-preferences 122 remains confidential except as authorized by a member. As My-e-surveys 150 builds a web page for a member and selects a survey or surveys for display, a topic list, along with My-e-preferences 122 information describing a member, may be passed by My-e-preferences 122 to My-e-surveys 150 to facilitate survey selection.

If a member meets criteria specified for a survey available from My-e-surveys 150, and survey topics are acceptable to a member, one or more surveys may be returned to My-e-surveys 150 and presented to a member. My-e-surveys 150 can select one or more survey questions from a survey database, which can include consumer-to-consumer surveys, customer sponsored surveys, and the like (“Survey Class”).

In addition to taking surveys, members will be able to create their own surveys. A new survey can be linked to any existing survey. The free creation of surveys, along with the linking mechanism, provides a new form of public discussion. Members can raise any issue and see how others feel about that by asking the right question. Members can also improve on questions asked by others, without changing the statement or opinion, but by changing the original question and answers. This enhances the competition between members, encourages members to raise issues in a clear and proper way, and creates a “natural evolution” process, since all surveys are competing for votes and for a better position due to the floating mechanism.

These surveys can be created by members or customers through a “Survey Wizard.” The survey wizard is a graphical interface which allows users to provide survey-specific information, such as, but not limited to, a statement, an opinion, a question, a list of possible answers, categories to which the survey applies, survey scheduling, and an E-mail address to which survey result summaries could be sent. All surveys are structured in a format that allows the data associated with the use and content of the surveys to be mined for later user by the customers.

The survey wizard may also simplify data entry by providing templates for various standard survey types, including, but not limited to, customer satisfaction surveys, market research surveys, and branded surveys. Templates can be used to automatically standardize specific options, such as, but not limited to, logo placement and public availability. By way of example, without intending to limit the present invention, a customer may use the survey wizard and an associated template to create a branded market research survey. Such a survey may contain a corporate logo or other identifier associated with a customer, but, rather than being readily available to the public, access to such a survey may be restricted in some manner by My-e-preferences 122, thereby targeting the survey to a specific audience.

A survey creator can also use the survey wizard to select from one or more survey answer display orders. Available survey answer display orders may include, but are not limited to, static, random, and floating. In a static survey, answers are ordered as indicated by a survey creator. In a random survey, survey answer order is chosen at random. A floating survey orders survey answers based on an Activity Index. Activity Indices are defined in detail later in this document.

Survey creators can also use the survey wizard to create a “Linked Survey.” A Linked Survey is a survey which shares the same topic and statement sections as another survey, but whose question and answers may be slightly different. Linked Surveys can be used to uncover subtleties which might otherwise go unnoticed using other forms of market research. Members responding to a survey may activate a link or other interface element to participate in a linked survey.

The survey wizard may also allow a survey creator to request that a copy of the Uniform Resource Locator (“URL”) that identifies a given survey be sent to an E-mail recipient or recipients. By sending such E-mail, a survey creator can notify individuals of the existence of a survey of interest.

When survey creation is complete, the survey wizard may search survey text for any offensive or unacceptable language. If such offensive or unacceptable language is found, the survey wizard may return an error, and a survey creator can edit survey contents and resubmit a survey.

The survey wizard may also perform natural language or other text analysis to determine if a submitted survey is similar to an existing survey. In the event the survey wizard finds one or more surveys that are similar to a submitted survey, the survey wizard may display the similar surveys and require submitter or administrative staff approval prior to accepting a submitted survey.

When an acceptable survey has been submitted, the survey wizard may return a unique survey identifier to a survey creator. By way of example, without intending to limit the present invention, a survey identifier may be used by a survey creator to modify a survey before its scheduled run date, track survey results and statistics, generate composite lists of surveys created, and to compensate survey creators if survey results are purchased by customers other than a survey creator.

Survey results available to members may differ from those available to customers. Members may be limited to only seeing the number of times a given answer is chosen, percentages associated with those results, and other basic information. Unlike members, customers can view more detailed demographic data, which can be gleaned by My-e-surveys 150 pulling demographic information from My-e-preferences 122 for each member who answers a question, and also further analyzing and sorting the results according to My-e-profile 121. Customers wishing to see detailed demographic data for surveys they did not create may be required to purchase such data, and a portion of the proceeds of each data sale can be credited to a survey creator's My-e-dollars 140 account.

My-e-surveys 150 can allow members and customers with access to survey results to view such results in real-time, and to sort survey results according to various criteria, including, but not limited to, total votes and activity index that is described in detail further in this document. My-e-surveys 150 can also create survey response summaries. Survey response summaries display only statistically significant information, such as, but not limited to, response levels for each answer, total number of votes, gender answer breakdowns, geographic region totals, and chronologically organized result summaries.

The potential member and customer revenue generated by the sale of survey data means that survey selection and placement are key components of My-e-surveys 150. When My-e-surveys 150 selects a survey for a member home page, consumer-to-consumer surveys may be chosen based on subject areas of interest to a particular member. Customer sponsored surveys may be similarly chosen.

Users may also gain access to additional surveys through My-e-surveys 150 by browsing My-e-surveys 150. To facilitate browsing, My-e-surveys 150 may organize surveys based on a variety of criteria, including, but not limited to, topic; submitter's name; date posted; total votes; controversy index; current ranking; highest ranking; achievement status, such as Survey of the Day, Survey of the Month, and the like; and number of linked surveys. Users may request a list of available surveys sorted by any organization criterion or combination of organization criteria.

The Survey of The Day component of the current invention displays the contents of My-e-surveys 150 that has the highest activity index within a given day across all communities, a particular community, or topic. The My-e-surveys 150 survey with the highest activity index is in fact the survey receiving the most attention in a given community or topic or the entire site.

“Survey of The Day” is the highest-ranking survey, based on our unique activity index, in every topic, every community, and the entire site. The three levels of Survey of The Day (topic/community/global) are one of the ways to reward the members creating them. The Surveys of The Day will be highly visible and will serve as one of the attraction generators for the appropriate levels.

In the preferred embodiment, the present invention can provide a dynamic page on both the Home and Community pages. If a member has already taken the survey displayed as the Survey of the Day, the survey page may be replaced with a result page displaying many additional components. Examples of these components may be, but are not limited to, the most recent survey results, various survey metrics, count of consecutive days as Survey of the Day, a link to the Top 10 surveys page and some user messaging explaining how surveys achieve Survey of the Day status. There might also be a detailed explanation on how My-e-surveys 150 “Float” or any other relevant information.

Surveys contained in My-e-surveys 150 may be categorized by subject and topic areas. Such categories may be selected by a consumer or customer submitting such a survey, or categories may be automatically determined through the use of natural language analysis or other text analysis means. In the event an automated text analysis is unable to categorize a given survey, My-e-surveys 150 staff can review a survey and assign it to an appropriate category or categories. Additional categories may be created by My-e-surveys 150 administrative staff based on customer or member requests.

During survey selection, My-e-surveys 150 may select one or more consumer-to-consumer surveys, and one or more customer sponsored surveys, for display. Each My-e-surveys 150 survey category can have associated with it one or more web pages, and a customer can pay to have a survey appear on one or more of such pages for a given period of time. In the event a web page is displayed for which no customers have purchased survey space, one or more appropriate, surveys may be chosen from My-e-surveys 150 based on survey category.

The present invention may include a service wherein a customer is given increased and personalized exposure to the members of the invention. Under this mechanism, customers may be able to “step up to the plate,” addressing members' and visitors' questions, comments, and ideas directly and dynamically, and in an interactive and innovative environment, thus availing themselves of a great opportunity to nurture positive public relations. This vehicle will pave the way for innovative, entertaining, and standardized methods for communicating, in a very targeted and focused manner, with consumers, as well as, reporting on a company's standing in the eyes of consumers.

The invention may include, but is not limited to, the following components: what Customer wants to say which is where the customer makes public announcements and statements; what Customer wants to ask which is where the customer collects Member Personal Information through surveys, polls, and other public opinion gauges, as well as, various automated and on-line, behavior and navigation monitoring and tracking processes (“surveys”); what Consumers want to say and/or ask the company which is where the consumers can take or make surveys and raise any issues that are of interest to them. Surveys may be displayed according to the activity index, so that the most popular surveys will “float” to the top of the list; and how Customers responds to what consumers have to say or ask which is where the company has an opportunity to address issues that are raised by the consumers in their surveys or in their responses to the surveys posted by the company.

In a preferred embodiment, when more surveys of a given Survey Class are appropriate for consumer display than there are survey display spaces, a survey with a higher response count, or Activity Index, may be chosen. In an alternative embodiment, an appropriate Activity Index may be calculated, and a survey with a higher Activity Index may be chosen for display. An activity Index may be based on two factors: how recently the survey was created, and recent survey activity.

A survey age factor (SAF) can be calculated using a formula similar to: SAF=24/(Age +1), where Age is the age of the survey in days. A survey recent activity factor (SRAF) can be I (Votes in period(i) * Period Const(i)) calculated using a formula such as:

$$SRAF = \frac{\sum ( Votes\_in \_period ( i ) * Period\_Const ( i ) )}{Total\_Votes + 1} .$$

To calculate a survey recent activity factor, survey result counts are weighed based on different periods in which such result were obtained; Table 1 lists sample periods and associated period weights (Period_{—Const.)}

Given an SAF and SRAF, an Activity Index can be calculated using a formula such as:

$$\text{Activity Index} = \frac{Total\_Votes * ( C1 * SAF + C2 * SRAF )}{C1 + C2} ,$$

where C1 is the relative weight assigned to a survey age factor, and C2 is the relative weight assigned to a survey recent activity factor.

TABLE 1

| I | Period | Period Const |
|---|---|---|
| 1 | Day 0 (today) | 8 |
| 2 | Day-1 (yesterday) | 7 |
| 3 | Day-2 | 6 |
| 4 | Day-3 | 5 |
| 5 | Day-4 | 4 |
| 6 | Day-5 | 3 |
| 7 | Day-6 | 2 |
| 8 | Week 0 (current week) | 8 |
| 9 | Week-1 | 1 |
| 10 | Week-2 | 1 |
| 11 | Week-3 | 1 |
| 12 | Month 0 | 8 |
| 13 | Month-1 | 1 |
| 14 | Month-2 | 1 |

In the above-described embodiment, as My-e-surveys 150 searches for a survey to be highest Activity Index that meets user preferences and corresponds to a given category may be chosen. If multiple surveys have the same Activity Index, a survey may be chosen at random from those with the highest Activity Index.

My-e-surveys 150, though use of the above equations and table are able to survey the popularity and activity of the various surveys without having to continuously query the voting database. In addition, the present invention is able to survey the popularity ranking of the surveys using a time, vote frequency, and vote distribution method.

My-e-surveys 150 may select consumer-to-consumer surveys in a manner similar to that which is used to select customer sponsored surveys. My-e-surveys 150 may also notify a survey creator when a given survey's Activity Index rises above a given level.

My-e-surveys 150 may further enable survey respondents to express their opinion about a given topic by allowing them to enter a short narrative after a survey. By way of example, without intending to limit the present invention, a survey respondent may use a narrative to explain that, of the answers present, a given answer is preferred, but that an alternative answer would have been preferred had it been available. My-e-surveys 150 can summarize received narrative responses and present both a summary and a full accounting of each narrative.

In an effort to keep its surveys as accurate as possible, My-e-surveys 150 may restrict survey respondents to only answering a survey once. While some users may choose to not answer a survey, those members answering a survey may be rewarded through loyalty tools or consumer services.

Such rewards may be available directly from licensees of the present invention, businesses in partnership with the system, businesses choosing to advertise directly on a web page provided by the system, and the like. As an example, a member filling out a survey may be rewarded by the addition of money to a consumer electronic currency account. The system provides for electronic currency through My-e-dollars 140.

My-e-dollars 140 is a system through which a member may be rewarded with electronic currency for performing an act. Acts which may qualify for rewards include, but are not limited to, providing and maintaining information stored in a consumer profile known as My-e-preferences 122, and stored in My-e-data 123; allowing advertisement on a consumer home page provided by My-e-surveys 150; allowing advertisements via E-mail or postal mail; visiting a web site maintained by an advertiser, business partner, or other system affiliate; participating in surveys; and allowing personal or demographic information (My-e-preferences 122) stored in My-e-data 123, to be used as part of market research. As consumers are rewarded with electronic currency, rewards may be tracked by My-e-dollars 140 in separate accounts for each consumer and used to purchase various goods and services.

For example, electronic currency provided by My-e-dollars 140 may be used to purchase entries in periodic sweepstakes. Electronic currency provided by My-e-dollars 140 may also be used instead of other forms of payment when purchases are made, or My-e-dollars 140 may be used to purchase coupons good toward merchandise or service discounts. Electronic currency provided by My-e-dollars 140 may be underwritten by a bank or other financial institution or organization, such as Visa, MasterCard, or American Express, to permit worldwide acceptance.

Although initially targeted at electronic commerce, electronic currency maintained by My-e-dollars 140 may be available for payment of more traditional transactions. For example, a My-e-dollars 140 account may be accessed from an Automated Teller Machine (“ATM”), thereby allowing both deposits and withdrawals, as with a traditional bank account. My-e-preferences 122 may also allow a member to interface with My-e-dollars 140 to pay bills, such as rent or utility bills, online.

A consumer may also access Internet resources through My-e-surveys 150. For example, a web page created by My-e-surveys 150 may facilitate access to a search engine, consumer-written product reviews, stock quotes, and other tools accessible as part of My-e-tools 130.

Traditional search engines store key words and phrases associated with various web pages across the Internet, and return a list of web pages that contain keywords specified by a user. My-e-tools 130 may expand upon a traditional search engine model by allowing a consumer to specify default parameters to be used by a search engine as part of the preferences stored in My-e-preferences 122 and My-e-data 123. Examples of search engine settings that may be stored in consumer My-e-preferences 122 include, but are not limited to, specific web sites to be searched; restrictions of objectionable language, pictures, or other forms of expression; or exclusion of specific web sites from searches.

In addition to a customizable search engine, My-e-tools 130 may also provide customizable stock quotes. My-e-tools 130 may allow a consumer to specify stocks to be included in updates, and allow a consumer to specify update frequencies. Updates may occur at specific times of day, at specific intervals, or updates may occur based on stock parameters, such as fluctuations in value or quantities traded.

My-e-tools 130 may also provide an interface to consumer generated product reviews. Product reviews may be generated through various means, including, but not limited to, surveys conducted by My-e-surveys 150 and stored in My-e-data 123, and general comments entered into My-e-surveys 150 and stored in my-e-data 123. Product reviews may be used by consumers before making a purchase. Product reviews may be delivered on demand to a web browser acting as part of My-e-surveys 150, or may be delivered through a variety of other means, including E-mail and voicemail.

In addition to delivering information on demand to a member through a web server and web browser, My-e-surveys 150 may deliver information through other media or other methods. Delivery methods employed by My-e-surveys 150 may include, but are not limited to, display on a dynamically updated web page; data or files that may be automatically sent to computers on which consumers are working; E-mails which may be sent on demand, at the occurrence of some event (such as breaking news or stock volume exceeding a customizable level), or at periodic intervals; electronic or voice messages sent to a device, such as a telephone or pager; facsimile (fax machine); or any combination of methods. Delivery preferences may be stored as part of member My-e-preferences 122, and may be edited by a member.

In addition to providing access to the Internet, My-e-surveys 150 may also facilitate member interaction with customers. To encourage this interaction, a member may, for example by answering a survey or filling out a form, indicate either an interest in purchasing a specific product/service (“product”) or an interest in a general class of products. Survey or form results may be stored in My-e-data 123 and My-e-preferences 122. Member preference changes made to My-e-data 123, via My-e-preferences 122, related to purchasing desires may cause My-e-profile 121 to notify On-Demand, Dynamic & Custom List Compiler (“List Compiler”) 160 of member needs.

List Compiler 160 may consolidate member purchase requests and periodically send consolidated request lists to Retailers, E-retailers, or Marketers, illustrated as Vendors 170. List Compiler 160 may also notify Vendors 170 immediately upon receipt of a purchase request, based on preferences of members and merchants included in Vendors 170. Notification to Vendors 170 may include only information authorized by a member, such as member names, preferred contact method, and contact information (e.g. phone number, E-mail address, or street address), to allow vendors to directly contact members. However, once a transaction is complete, a customer may not contact a member unless authorized by a member.

If a member chooses so, all communications and fulfillment can be routed via and handled by List Compiler 160 in which case Vendors 170 would not have any identifying information. This option would enable the member to enable or disable communications from Vendors according to My-e-preferences 122.

A member may also indicate that personal information is only to be given out as “aggregate data.” Members included in an aggregate data list may be included for statistical purposes, but an individual member may not be identified to a customer. In the event a customer wishes to advertise to a member who is only available as aggregate data, a customer may send an advertisement or other communication through List Compiler 160.

The model of member/customer interaction utilized in the present invention may be illustrated by the following example: a member may indicate that she is interested in purchasing a sport utility vehicle, and may narrow her choice to three models through a web page delivered as part of My-e-tools 130 or My-e-preferences 122. This request may be stored in My-e-data 123 and/or My-e-preferences 122, and may be passed to List Compiler 160 or directly to Vendors 170 through My-e-profile 121.

List Compiler 160 may contact various vendors and indicate member interest in a model of sport utility vehicle carried by a vendor. The system may also supply member names and preferred contact method or methods to Vendors 170. Vendors 170 may contact members directly with respect to a particular transaction, or Vendors 170 may advertise to members through My-e-classifieds 113, my-e-ads 112 or my-junk mail 111.

Member advertisement delivery may be accomplished through a variety of methods, including, but not limited, to display on a member home page, E-mail, and traditional direct mail. As a member responds to advertisements, a member My-e-preferences 122 may be enhanced to include advertisement information such as, but not limited to, manufacturer, brand preferences, and product classification. Information stored in My-e-data 123 and My-e-preferences 122 as part of member profiles may also be used for market analysis.

Market analysis requires collection of consumer preference data across a broad marketplace. Market analysis has traditionally been performed through surveys and polls conducted by mail or telephone. Although there are several companies and organizations that perform polling, which increases competition and helps keep the total cost of the poll down, polls are traditionally very expensive, due to high data collection costs.

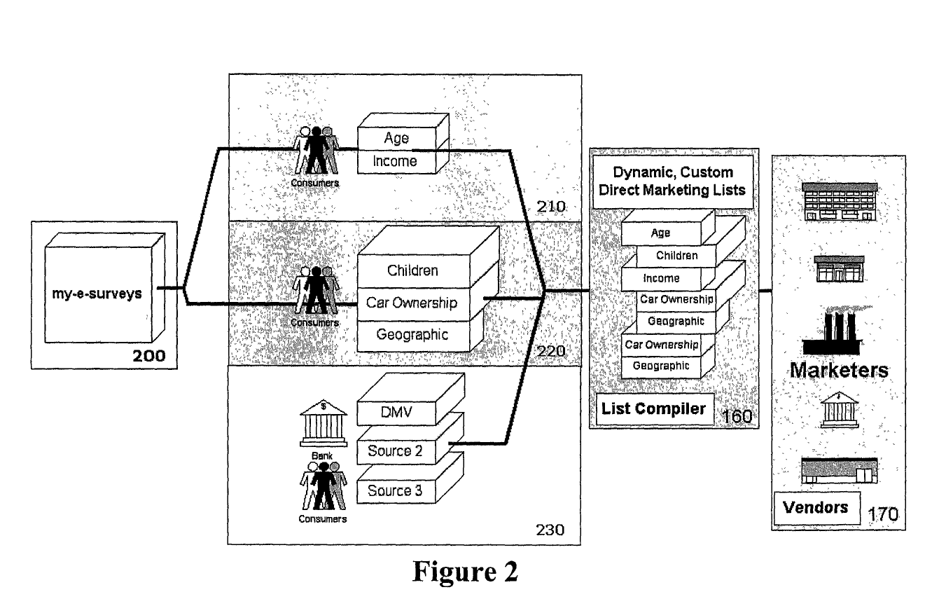

My-e-data 123 and My-e-surveys 150 may facilitate a convergence of presently collected data and data collection methods used by disparate data-collection companies into a single data warehouse. As illustrated in FIG. 2, a data warehouse may consolidate data collected from other companies into My-e-data 123. A data warehouse may also associate data stored in My-e-data 123 and My-e-surveys 150 with consumer preferences stored in My-e-preferences 122.

In addition to surveys conducted through My-e-surveys 150, alternate survey methods, both electronic and paper based, may be used to enhance the data stored in My-e-surveys 150 and my-e-data 123. Alternate survey methods may include, but are not limited to, postal mail, E-mail, kiosks, handheld communications devices, and voicemail polls. These more diversified approaches may allow the system to poll an extremely broad population cross-section, further increasing the value and reliability of data stored in my-e-data 123 and My-e-surveys 150.

A data warehouse approach, combined with a reward-driven survey and polling interface based on My-e-surveys 150 and My-e-dollars 140, may significantly reduce data collection costs while providing an infrastructure for intelligent data use. My-e-data 123 is also gathered from consumer response to surveys created by members and therefore reflects what issues are on the consumers' minds in addition to consumers' opinion on a specific issue that is of interest to the customers. This unprecedented access to information may encourage a stronger exchange of ideas and opinions and, ultimately, may shape the Internet into a more culturally rich environment.

The wide range of data sources used to populate My-e-data 123 and My-e-preferences 122, as well as the interrelation of various data collected by My-c-surveys 150 may create a powerful marketing infrastructure. This infrastructure may yield products for, but not limited to:

1) Public opinion surveys;

2) Custom market and product research;

3) On-demand surveys;

4) On-line one-to-one marketing;

5) On-demand list preparation;

6) Traditional direct marketing;

7) Product registration and consumer retention programs; and

8) Custom news, media, and entertainment programming.

9) Public relationship

10) Customer Relationship Management

11) Crisis Management

By unifying data collected through the Internet with data currently maintained by other sources, creation of more targeted and focused lists of potential consumers may be facilitated. The present invention may revise and extend current polling and survey models by utilizing a powerful, low-cost data collection media, the Internet, and linking voluntary disclosure of public opinion and demographic information with proven loyalty programs. My-e-surveys 150 may deliver to customers a powerful, low cost method of quickly surveying the Internet population in general, or a specific cross-section of the Internet, through interaction of My-e-surveys 150, My-e-profile 121, My-e-preferences 122, and my-e-data 123.

As illustrated in FIG. 2, the presently preferred embodiment of My-e-surveys 150 may supply survey results to a customer dynamically through a web page. Additional survey result delivery methods may also be used, including E-mail, facsimile, and electronic or voice messages sent to a device, such as a telephone or pager.

As survey results increase in number and approach statistical significance, news, government, and/or media partners may be contacted by the present invention. In this way, survey results may generate programming content for news, media, and entertainment customers.

In addition to providing market analysis, the combination of My-e-surveys 150 and data collected from various public opinion, market research, and direct marketing sources into a data warehouse may allow highly targeted marketing by creating lists of potential consumers based on data stored in a data warehouse. FIG. 2 illustrates this process. In FIG. 2, List Compiler 160 (which is also illustrated in FIG. 1) can supply a list of potential consumers to customers (illustrated as Block 170 of both FIG. 1 and FIG. 2). A potential consumer list may be created from based on data specified by customers (illustrated as Age, Children, Income, Car Ownership, and Geographic in FIG. 2).

The interaction of various components of the present invention when creating a potential consumer list may be further illustrated in conjunction with FIG. 1. List Compiler 160 may be used by Media Companies and List Brokers 180 or Vendors 170 to request a list of potential consumers. As requests are received from Vendor 170 or Media Companies 180, List Compiler 160 may generate a list of potential consumers from information stored in My-e-profile 121 and My-e-preferences 122 based on criteria set forth in a list request. A consumer whose profile requests nondisclosure of personal information may be excluded from a generated list.

The lists generated by List Compiler 160 may allow merchants to advertise their products to specific groups of potential or past consumers, thus reducing advertising costs and increasing rates of return on marketing investments.

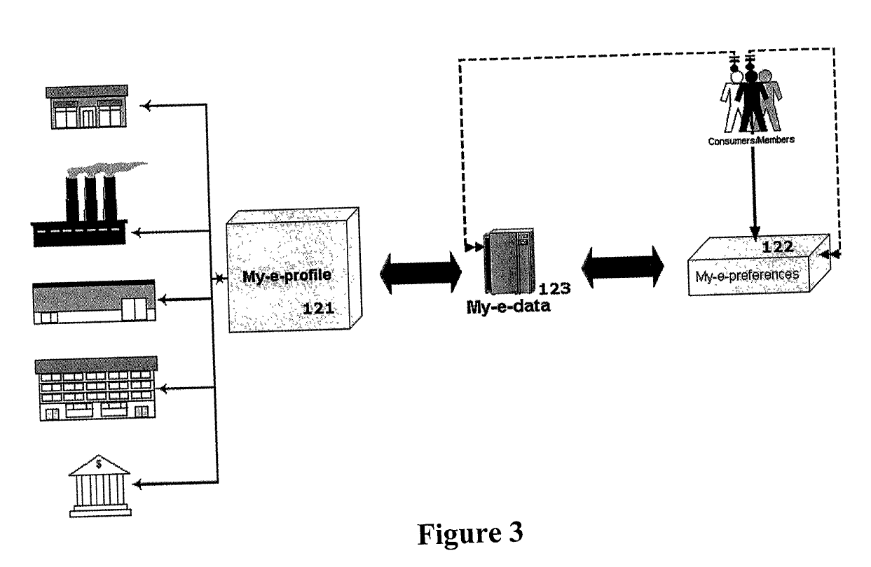

FIG. 3 illustrates a distinction between My-e-profile 121, My-e-data 123, and My-e-preferences 122. As illustrated in FIG. 3, My-e-profile 121 may serve as an interface between customers and consumers. A customer wishing to determine general product marketability may initially request the number of members to whom a particular product may appeal, based on certain demographic or other information, which may be stored in My-e-data 123. My-e-data 123 may look through consumer preferences, stored in My-e-preferences 122, and select those consumers allowing personal information to be used in aggregate, broad-market research. Personal preferences of selected consumers may then be reviewed by My-e-data 123, and a number may be returned to a customer through My-e-profile 121.

In summary, the present invention allows creation of a custom Internet browsing experience based on consumer preferences. In addition, the present invention may give a member an opportunity to participate in polls and surveys, thus allowing a member to help shape the world around them. The present invention may also allow tracking of consumer survey results, consumer spending habits, consumer brand preferences, and other survey results, to facilitate highly targeted marketing both within and outside the system. In exchange for allowing monitoring of member behavior patterns, members may be rewarded with various incentives, including but not limited to electronic currency.

While the preferred embodiment and various alternative embodiments of the invention have been disclosed and described in detail herein, it may be apparent to those skilled in the art that various changes in form and detail may be made therein without departing from the spirit and scope thereof.

I claim:

1. A system for collecting consumer data comprising:
a user interface,
software associated with said interface for monitoring a user interaction; and
a database for storing a plurality of data related to said user interaction.

2. The system as described in claim 1, wherein said user interface displays at least one public opinion gauge.

3. The system as described in claim 2, wherein said at least one public opinion gauge is a survey.

4. The system as described in claim 1, wherein said user interface displays advertisements.

5. The system as described in claim 1, wherein said database has an architecture through which said plurality of said user interaction data can be provided to a third-party.

6. The system as described in claim 5, wherein said plurality of said user interaction data contains a group of user-specific information.

7. The system of claim 6, wherein said group of user specific information can be withheld from disclosure to said third party.

8. The system as described in claim 1, wherein said consumer data contains user demographic data.

9. The system as described in claim 1, wherein said consumer data contains user preference data.

10. A system as described in claim 1, wherein said software tracks user activities with said user interface and provides rewards for specific activities.

11. A system as described in claim 1, wherein said user interface is displayed on a traditional computer.

12. A system as described in claim 1, wherein said user interface is displayed on a kiosk.

13. A system as described in claim 1, wherein said user interface is displayed on a portable computing device.

14. A system as described in claim 1, wherein said user interface includes audible, tactile, and olfactory stimulation in addition to visual stimulation.

15. A system as described in claim 2, wherein said user interface displays at least one of a plurality of other content including news, entertainment, or other multimedia content along with said at least one public opinion gauge.

16. A method of collecting consumer data comprising the steps of:
providing an electronically accessible user interface,
monitoring user interaction with said interface; and
storing a plurality of data based upon said user interaction.

17. The method of claim 16, further comprising the step of:
displaying at least one public opinion gauge on said user interface.

18. The method of claim 17, further comprising the step of:
providing incentives for interaction with said interface.

19. The method of claim 16, further comprising the step of:
providing said plurality of data on user interaction to a customer.

20. The method of claim 19, further comprising the step of:
filtering said plurality of data on user interaction provided to said customer to allow only data approved by said user to be provided.

21. A method for determining which public opinion gauge to display based on consumer preferences comprising the steps of:
determining a consumer user's personal information,
determining a consumer user's preferred public opinion gauge categories;
analyzing existing public opinion gauges based upon said consumer user's personal information and said consumer user's preferred public opinion gauge categories;
ranking said public opinion gauges based upon said analysis; and
displaying said public opinion gauge based upon said ranking.

22. A method for determining which public opinion gauge to display based upon activity comprising the steps of:
calculating a public opinion gauge age factor;
calculating a public opinion gauge recent activity factor;
calculating an activity index based upon said public opinion gauge age factor and public opinion gauge recent activity factor; and
displaying a public opinion gauge based upon said activity index.

23. The method of claim 22, further comprising the step of:
determining the activity index without querying a voting database.

24. The method of claim 22, further comprising the steps of:
determining said activity index based upon a time period, a vote frequency and a vote distribution.

25. The method of claim 22, further comprising the step of:
calculating said activity index including using a weighting factor for newly created surveys thereby compensating for a low vote count.

26. A method for providing direct interaction between a consumer a company comprising the steps of:
providing an Internet portal community with a consumer user interface for the collecting consumer information and opinions;
providing a company direct access to said consumer user interface to address the consumer opinions.

27. A method of mining consumer user data from an interactive public opinion gauge comprising the steps of:
providing a public opinion gauge as part of a user interface on an Internet portal site;
structuring said public opinion gauge to allow for data related to consumer interaction with said public opinion gauge to be retrieved; and
capturing data related to consumer interaction with said public opinion gauge.

28. A method of providing rewards to a consumer for the collection and dissemination of consumer information comprising the steps of:
providing an Internet portal community for a consumer to input personal information;
tracking consumer internet portal activity;
collecting said consumer input information and said activity information;
providing rewards to consumers to share collected information; and
disseminating said information to companies thereby triggering an automatic payment of said rewards incentives to said consumers.

29. The method of claim 28, further comprising the steps of:
providing said consumers with predefined levels of information dissemination.

30. A method of formulating a consumer public opinion gauge comprising the steps of:
providing an Internet portal community within an Internet portal system where a consumer users can interact with a public opinion gauge;
providing a software application within said Internet portal system, which allows said consumer user to create a new interactive public opinion gauge; and
presenting said new interactive public opinion gauge within said Internet portal community.

31. The method of claim 30, further comprising the step of:
linking said new interactive public opinion gauge to a pre-existing interactive public opinion gauge based upon similar topics thereby creating a public opinion discussion forum.
